(19) United States
(12) Patent Application Publication
(10) Pub. No.: US 2023/0143736 A1
(43) Pub. Date: May 11, 2023

(54) UNIVERSAL, PREFABRICATED FOUNDATION SYSTEM FOR ELECTRIC VEHICLE CHARGING STATIONS

(71) Applicant: GreenCore EV Services LLC, Englewood, CO (US)

(72) Inventors: Frank A. Baumann, Rio Rancho, NM (US); Frank M. Baumann, Rio Rancho, NM (US); Robert A. Baumann, Rio Rancho, NM (US)

(21) Appl. No.: 17/521,143

(22) Filed: Nov. 8, 2021

(51) Int. Cl. E02D 27/46; B60L 53/30

(52) U.S. Cl. CPC E02D 27/46; B60L 53/30; H02J 7/0013

(57) ABSTRACT

A prefabricated foundation system for mounting one or more electric vehicle charging stations is provided. The prefabricated foundation system includes a body, including a top opening, a plurality of sidewalls, and a plurality of sidewall openings, wherein each of the plurality of sidewalls includes at least one sidewall opening. The prefabricated foundation system further includes a lid configured to be secured to the body over the top opening. The lid includes a lid opening configured to receive one or more components of the one or more electric vehicle charging stations.

### BACKGROUND

### Statement of the Technical Field

The present disclosure relates to foundation systems for electric vehicle charging stations and, in particular, to foundation systems configured to receive electric vehicle charging station equipment of various shapes and sizes.

### Description of the Related Art

Electric vehicles are becoming ever more prevalent in the modern age. In the United States alone, there are hundreds of thousands of electric vehicles on the road. There are differing types of electric vehicle, ranging from, for example, purely electric to semi-electric.

Many electric vehicles are purely electric vehicles in that they do not have the option of running on electricity or gas. Since these vehicles cannot run on gas, they cannot refuel at standard gasoline stations. Instead, these vehicles must be plugged into an electrical outlet in order to recharge. While gasoline stations are plentiful in many countries, electric vehicle charging stations are vastly less so. As more electric vehicles enter the roadways, the need for electric vehicle charging stations increases.

The installation of electric vehicle charging stations often requires the installation of foundation systems onto which the electric vehicle charging stations are mounted. However, these foundation systems are often bulky, complex, and non-user friendly. Additionally, foundation systems are configured to enable an electric vehicle charging station of a specific shape and size to be mounted thereon, requiring a differently designed foundation system for each type of electric vehicle charging station.

For at least these reasons, a user friendly, light-weight, and adaptable foundation system for mounting one or more electric vehicle charging stations is required.

### SUMMARY

According to an aspect of the present disclosure, a prefabricated foundation system for mounting one or more electric vehicle charging stations is provided. The prefabricated foundation system includes a body, including a top opening, a plurality of sidewalls, and a plurality of sidewall openings, wherein each of the plurality of sidewalls includes at least one sidewall opening. The prefabricated foundation system further includes a lid configured to be secured to the body over the top opening. The lid includes a lid opening configured to receive one or more components of the one or more electric vehicle charging stations.

According to various embodiments, the body includes one or more of: cement; and concrete.

According to various embodiments, the lid is removably secured to the body.

According to various embodiments, the lid includes at least one opening into the top opening.

According to various embodiments, the prefabricated foundation system further includes one or more securing mechanisms configured to secure the lid to the body over the top opening.

According to various embodiments, the one or more securing mechanisms includes one or more of: screws; bolts; nails; and adhesive.

According to various embodiments, the plurality of sidewall openings taper toward an inner surface of the body.

According to various embodiments, the body includes a bottom wall.

According to various embodiments, the plurality of sidewalls is four sidewalls.

According to various embodiments, the plurality of sidewall openings are configured to enable conduit to pass through one or more of the sidewall openings.

According to various embodiments, the plurality of sidewall openings are configured to enable a hardenable material to pass through one or more of the sidewall openings.

According to various embodiments, the hardenable material includes control low strength material.

According to various embodiments, the body is constructed out of a singular piece of material.

According to various embodiments, the body is divided into a plurality of chambers.

According to various embodiments, the plurality of sidewall openings are positioned such that access is provided, through the plurality of sidewall openings, to each of the plurality of chambers.

### BRIEF DESCRIPTION OF THE DRAWINGS

FIG. 1 illustrates a perspective view of a prefabricated foundation system, in accordance with various embodiments of the present disclosure.

FIG. 2 illustrates a perspective view of a body of a prefabricated foundation system, in accordance with various embodiments of the present disclosure.

FIG. 3 illustrates a perspective view of a lid of a prefabricated foundation system, in accordance with various embodiments of the present disclosure.

FIGS. 4A-4B illustrate an isometric view (FIG. 4A) and a front view (FIG. 4B) of a prefabricated foundation system body, in accordance with various embodiments of the present disclosure.

FIG. 5 illustrates an isometric view of a prefabricated foundation system body, in accordance with various embodiments of the present disclosure.

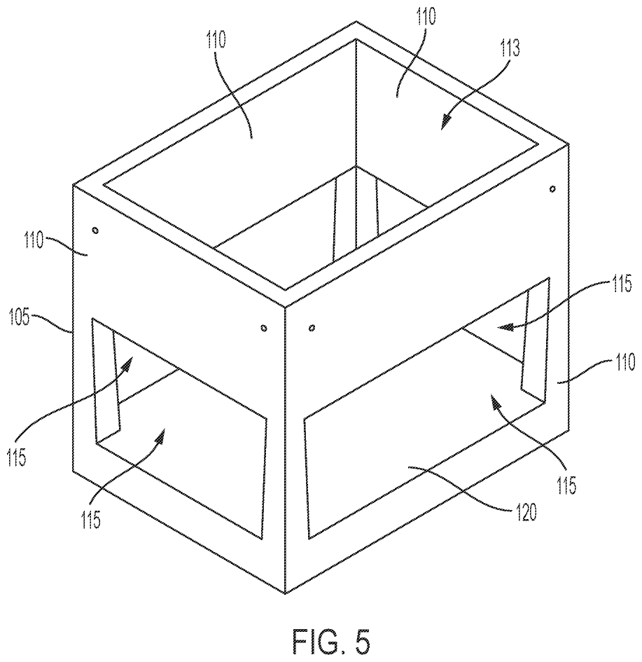

FIGS. 6A-6C illustrate perspective views of lids of a prefabricated foundation system, in accordance with various embodiments of the present disclosure.

FIG. 7 illustrates a cutaway view of a lid mounted on a body of a prefabricated foundation system, in accordance with various embodiments of the present disclosure.

FIG. 8 illustratively a series of prefabricated foundation systems having conduit installed therethrough, in accordance with various embodiments of the present disclosure.

FIG. 9 illustratively a series of prefabricated foundation systems having a hardenable material applied therethrough, in accordance with various embodiments of the present disclosure.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

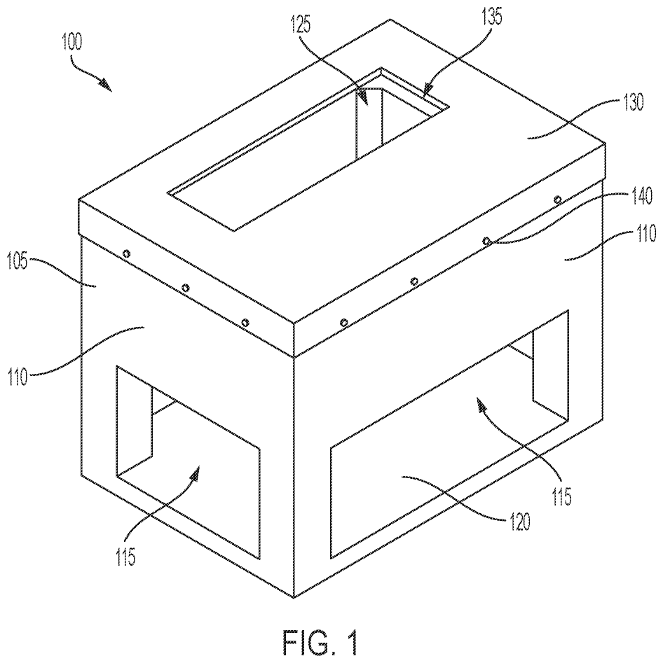

Referring now to FIG. 1, a prefabricated foundation system 100 configured to be integrated with one or more electric vehicle charging stations is illustratively depicted, in accordance with various embodiments of the present disclosure.

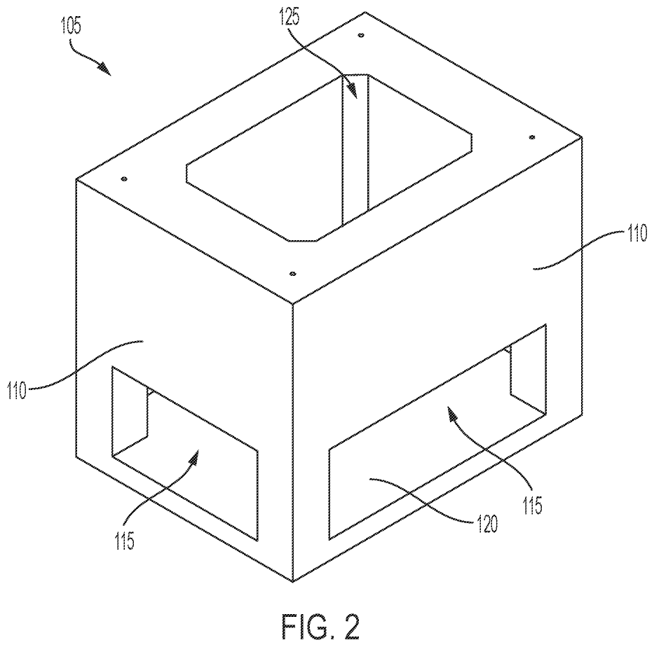

According to various embodiments, the prefabricated foundation system 100 includes a body portion 105 (shown in more detail in FIG. 2), having a plurality of sidewalls 110, and a lid portion 130. The body 105 includes at least one opening 115 in each of the plurality of sidewalls 110. According to the embodiment shown in FIG. 1, the prefabricated foundation system 100 includes 4 sidewalls 110 and an opening 115 in each of the sidewalls.

Since the foundation system 100 is prefabricated, the more weight the system 100 has, the more unwieldy and difficult to move and position the system 100 becomes. The plurality of openings 115 in the sidewalls 110 decreases the weight of the prefabricated foundation system 100, which decreases installation and shipping costs and decreases installation times. The plurality of openings 115 additionally provides greater access to the internal structure of the prefabricated foundation system 100 causing the prefabrication foundation system 100 to be more user friendly by aiding users during conduit manipulation and installation processes.

According to various embodiments, the body 105 includes a hardened material such as, e.g., cement, concrete, and/or other suitable materials. According to various embodiments, the body 105 is a singular structure formed from a single piece, decreasing the complexity of the prefabricated foundation system. It is noted, however, that, in other embodiments, the body 105 includes two or more components.

According to various embodiments, the openings 115 of the body 105 taper inward towards the center of the body 105. When the body 105 is formed via a mold, the taper enables spacers (used to hold the shape of the openings 115) to be removed from the body 105 subsequent to the formation of the body 105. The body 100 may include a bottom wall 120 to aid in securing the body 105 during installation.

The body 100 is configured to be partially or entirely underground when installed. According to various embodiments, the body 105 is configured to receive a hardenable material. The hardenable material may be, for example, cement, concrete, resin, plaster, and/or any other suitable hardenable material. According to various embodiments, the hardenable material is concrete such as, e.g., flowable fill, which is similarly known as Control Low Strength Material (CLSM). The flowable fill is configured to flow through the openings 115 and over any foundations, conduit, grounding systems, and/or any other suitable structures or devices. According to various embodiments, the flowable fill has a minimum density of approximately 15 pcf. It is noted, however, that, in various embodiments, flowable fill with other suitable densities may be used.

Once the body 105 is set in place and the hardenable material set, the prefabrication foundation system 100 can be secured in place. By enabling the hardenable material to fill all or a portion of each of the sidewalls 110, the body 105 has more points of contact with the hardenable material, increasing the stability of the prefabricated foundation system 100 once the prefabricated foundation system 100 is installed.

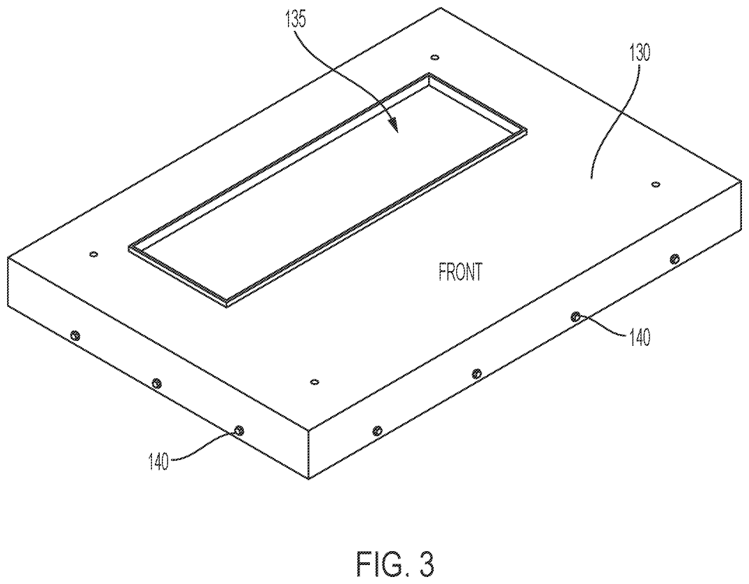

According to various embodiments, the body 105 includes a top opening 125. The prefabricated foundation system 100 further includes a lid 130 (shown in more detail in FIG. 3) positioned on an upper portion of the body 105, over the top opening 125. According to various embodiments, the lid 130 includes a material different from the body 105. It is noted, however, that, in other embodiments, the lid 130 and the body 105 include one or more of the same or similar materials. According to various embodiments, the lid 130 includes steel, aluminum, and/or other suitable materials. The lid 130 is secured to the body via one or more securing means 140. The one or more securing means 140 may include bolts, screws, adhesives, nails, and/or any other suitable form of securing mechanism.

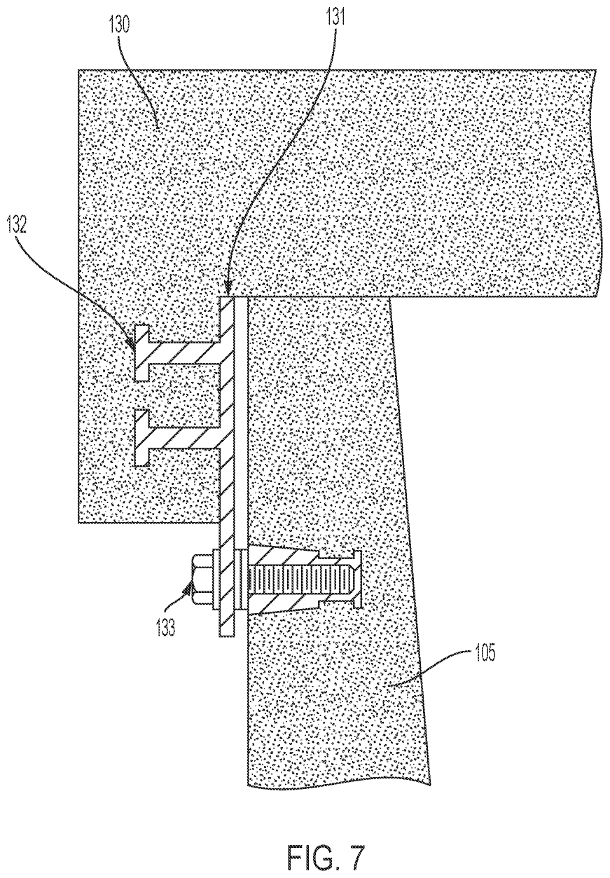

An example securing mechanism is shown in FIG. 7. As shown in FIG. 7, the lid 130 may include an anchor plate 131. According to various embodiments, the anchor plate 131 can be secured to the lid 130 via one or more securing means such as, as shown in FIG. 7, one or more anchor studs 132 secured (e.g., welded, etc.) to the anchor plate 131. According to various embodiments, the lid 130 can be secured to the body 105 via the anchor plate 131 using a securing means such as, for example, a screw 133 and/or other suitable means.

According to various embodiments, the lid 130 is removably secured to the body 105, enabling the lid 130 to be removed from the body 105 to be, for example, repaired and/or replaced.

The lid 130 includes an opening 135 configured to receive one or more components of various electric vehicle charging stations of various shapes and sizes. According to various embodiments, the lid 130 may be secured to the body 105.

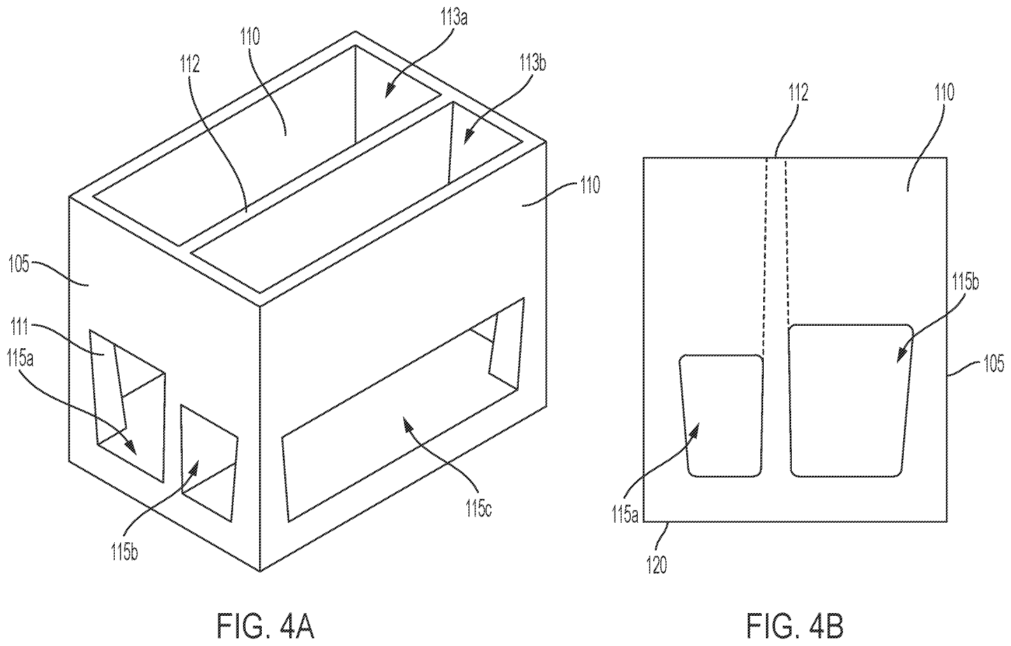

It is noted that the prefabricated foundation system 100 can, according to various embodiments, take other forms and shapes. For example, as shown in FIGS. 4A-4B, an isometric view (FIG. 4A) and a front view (FIG. 4B) of a prefabricated foundation system 100 body portion 105 are illustratively depicted.

According to various embodiments, the prefabricated foundation system 100 of FIGS. 4A-4B includes a body portion 105 having a plurality of sidewalls 110 forming a generally rectangular outer perimeter shape. The body 105 includes a plurality of openings 115a, 115b, 115c in the plurality of sidewalls 110. The openings 115a, 115b, 115c, as shown in FIGS. 4A-4B, are of differing shapes and sizes. It is noted, however, in some embodiments, all or a plurality of the openings are of a same or similar shape and/or size.

According to the embodiment shown in FIGS. 4A-4B, the openings 115a, 115b, 115c narrow along the sidewalls 110 as they extend from a top side of the openings toward a bottom side of the openings. It is further noted, as shown in FIGS. 4A-4B, that, in some embodiments, the sidewalls 110 extend toward an interior of the body 105, as shown, for example, at wall 111 which slopes toward an interior of the body 105.

The prefabrication foundation system 100 can include one or more chambers within the body 105. As shown in FIGS. 4A-4B, wall 112 separates a top opening of the body 105 into a first chamber 113a and a second chamber 113b. According to various embodiments, the chambers may be configured for utility access and/or customer access. As shown in FIGS. 4A-4B, at least one sidewall 110 includes an opening 115a, 115b to each of the first chamber 113a and second chamber 113b.

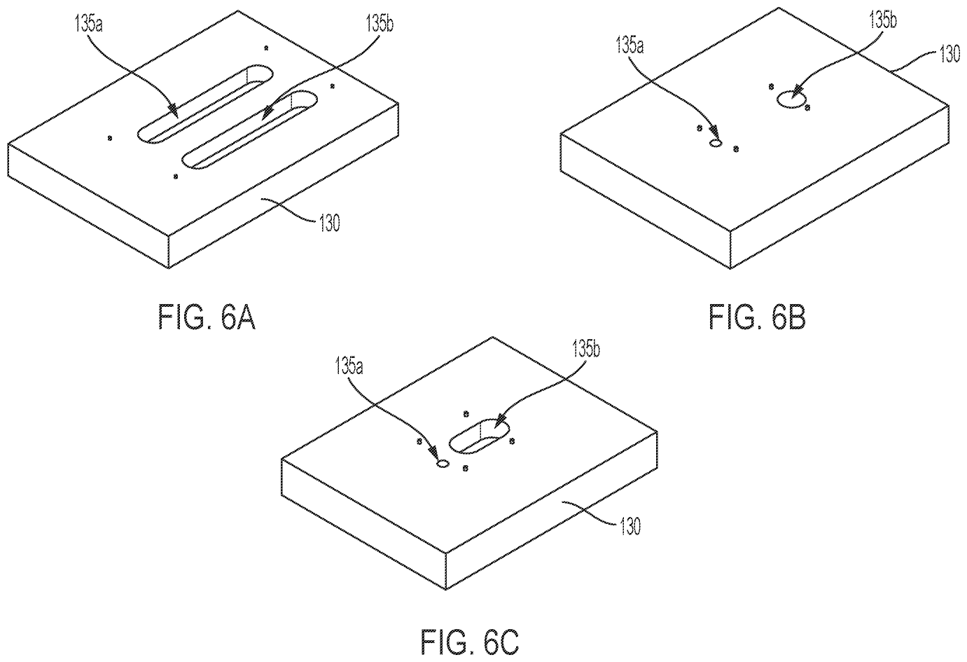

According to various embodiments, the sidewalls may have more or fewer openings 115 or chambers 113. For example, as shown in FIG. 6, a prefabricated foundation system 100 body 105 is illustrated which has one opening 115 per sidewall 110 and a single chamber 113.

According to various embodiments, as the body 105 of the prefabricated foundation system 100 can include multiple configurations, so can the lid 130. As shown in FIGS. 6A-6C, three lid 130 designs are shown. According to some embodiments, the lid can have a plurality of openings 135a, 135b, such as shown in FIGS. 6A-6B. According to some embodiments, such as that shown in FIG. 6A, the openings 135a, 135b are of relatively equal size. According to some embodiments, such as that shown in FIGS. 6B-6C, the openings 135a, 135b are of non-equal size. According to various embodiments, the openings 135a, 135b are aligned with the chambers 113 of the body 105.

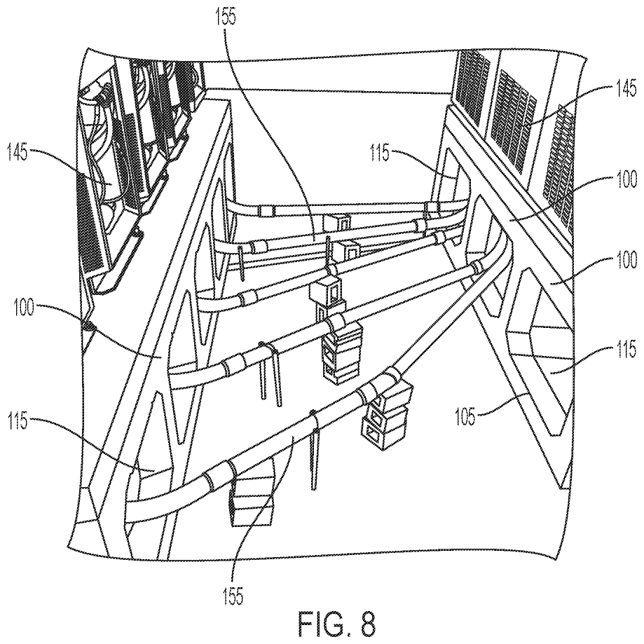

Referring now to FIG. 8, a series of prefabricated foundation systems 100 having conduit 155 installed therethrough is illustratively depicted, in accordance with various embodiments of the present disclosure.

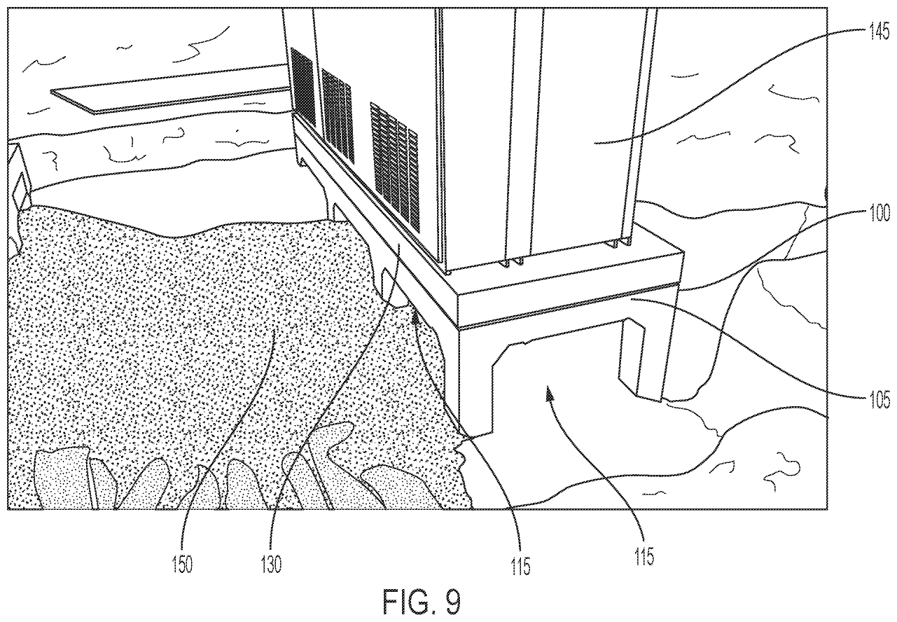

As shown in FIG. 8, the electric vehicle charging stations 145 are mounted onto the prefabricated foundation systems 100 and the openings 115 are configured to easily enable the conduit 155 to pass through the openings 115 of the body 105 of the prefabrication foundation systems 100. Once the conduit 155 is installed, the hardenable material 150 is poured onto the conduit and through the openings 115, as shown in FIG. 9. Once hardened, the hardenable material 150 securely fastens the prefabricated foundation systems 100 into the ground.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A prefabricated foundation system for mounting one or more electric vehicle charging stations, comprising:
a body, including:
a top opening;
a plurality of sidewalls; and
a plurality of sidewall openings, wherein each of the plurality of sidewalls includes at least one sidewall opening; and
a lid configured to be secured to the body over the top opening,
wherein the lid includes a lid opening configured to receive one or more components of the one or more electric vehicle charging stations.

2. The prefabricated foundation system of claim 1, wherein the body includes one or more of: cement; and concrete.

3. The prefabricated foundation system of claim 1, wherein the lid is removably secured to the body.

4. The prefabricated foundation system of claim 1, wherein the lid includes at least one opening into the top opening.

5. The prefabricated foundation system of claim 1, further comprising:
one or more securing mechanisms configured to secure the lid to the body over the top opening.

6. The prefabricated foundation system of claim 5, wherein the one or more securing mechanisms includes one or more of: screws; bolts; nails; and adhesive.

7. The prefabricated foundation system of claim 1, wherein the plurality of sidewall openings taper toward an inner surface of the body.

8. The prefabricated foundation system of claim 1, wherein the body includes a bottom wall.

9. The prefabricated foundation system of claim 1, wherein the plurality of sidewalls is four sidewalls.

10. The prefabricated foundation system of claim 1, wherein the plurality of sidewall openings are configured to enable conduit to pass through one or more of the sidewall openings.

11. The prefabricated foundation system of claim 1, wherein the plurality of sidewall openings are configured to enable a hardenable material to pass through one or more of the sidewall openings.

12. The prefabricated foundation system of claim 1, wherein the hardenable material includes control low strength material.

13. The prefabricated foundation system of claim 1, wherein the body is constructed out of a singular piece of material.

14. The prefabricated foundation system of claim 1, wherein the body is divided into a plurality of chambers.

15. The prefabricated foundation system of claim 14, wherein the plurality of sidewall openings are positioned such that access is provided, through the plurality of sidewall openings, to each of the plurality of chambers.
